(19) United States
(12) Patent Application Publication
(10) Pub. No.: US 2007/0171929 A1
(43) Pub. Date: Jul. 26, 2007

(54) Queue management in a network processor

(76) Inventors: Bong-Cheol Kim, Suwon-si (KR); Sun-Gi Kim, Seoul (KR); Yong-Seok Park, Seongnam-si (KR)

Correspondence Address: Robert E. Bushnell, Suite 300, 1522 K Street, N.W., Washington, DC, 20005-1202, US

(21) Appl. No.: 11/642,855

(22) Filed: Dec. 21, 2006

(30) Foreign Application Priority Data
Jan. 24, 2006 (KR) 10-2006-0007483

(51) Int. Cl. H04L 12/56

(52) U.S. Cl. 370/412; 370/389

(57) ABSTRACT

In a queue management method and apparatus in a network processor, enqueue completed and de-queue completed messages are transmitted to a scheduler when a queue manager performs enqueuing and de-queuing operations in the network processor, so that the queue processing time is synchronized between the queue manager and the scheduler. The queue manager in the network processor performs the de-queuing operation, includes the packet size information extracted from de-queued packet identification information in the de-queue completed message, and transmits it to the scheduler, so that the scheduler calculates the correct quantum of the port and queue.

### CLAIM OF PRIORITY

This application makes reference to, incorporates the same herein, and claims all benefits accruing under 35 U.S.C. §119 from an application for APPARATUS AND METHOD FOR A QUEUE MANAGEMENT OF NETWORK PROCESSOR earlier filed in the Korean Intellectual Property Office on the 24^{th} of January 2006 and there duly assigned Serial No. 10-2006-0007483.

### BACKGROUND OF THE INVENTION

1. Field of the Invention

The present invention relates to a method and apparatus for queue management in a network processor.

2. Description of the Related Art

In general, different types of traffic with various sizes and transmission speeds flow over the Internet. A queue managing scheme and a queue scheduling scheme are used for smooth traffic flow and efficient traffic management on the Internet.

As transmission technology is being developed to accommodate the explosive increase in Internet traffic, queue managing and scheduling schemes capable of providing various services (e.g., MPLS, MPLS VPN, IP VPN and QoS) while guaranteeing faster transmission have become increasingly important.

A queue managing and scheduling operation is performed by a network processor. The network processor mainly performs packet classification, packet modification, queue/policy management, packet forwarding, and the like.

In packet classification, a packet is identified based on features of a destination such as an address or a protocol. In packet modification, a packet is modified to be suitable for IP, ATM, or other protocols.

In queue/policy management, a design strategy for packet queuing, de-queuing and scheduling is reflected for specific applications. In packet forwarding, transmission of data to and reception of data from a switch fabric or an upper level application are performed and forwarding or routing of packets to a suitable address is performed.

The network processor interfaces with a physical layer/data link layer. The network processor can interface with another network processor performing other functions or can interface with a switch fabric to transmit and receive packets.

In general, the network processor is connected to physical layer/data link layer hardware for performing packet forwarding. The network processor stores packets received from the physical layer/data link layer hardware in a packet buffer. Information related to received packets, such as a packet size and a packet storage position, is managed by packet identification information (packet descriptor), and the packet identification information is managed by a queue manager before a packet received by a scheduler is transmitted to an output port.

In such a network processor, however, only the queue manager maintains and manages overall information about packets through the packet identification information, and a message is transmitted to the scheduler only when a packet is first enqueued in a queue or a last packet is de-queued, so that the scheduler actually manages only whether there are packets to be scheduled, for example, in a bitmap fashion, not actual information about the queue.

That is, the network processor provides limited information to the scheduler only when there is a queue state change (empty→non-empty, or non-empty→empty).

Accordingly, the scheduler can schedule more packets than actually enqueued packets, and accordingly, the queue manager receives different de-queue messages and performs error processing, such that the queue manager and the scheduler, which are independent from each other, cause a difference in queue processing performance or time. These processes significantly waste system resources.

Furthermore, since the scheduler in the network processor has significantly limited available packet information, it cannot obtain correct packet size information needed for actual scheduling. This causes a significant error in calculating a quantum of a port and a queue for scheduling.

That is, since the quantum is a value obtained by changing a relative ratio of queue bandwidths in the same port, a remaining quantum value can be different from the packet size when a scheduler performs a scheduling operation. When the remaining quantum value is greater, the scheduler is not allowed to schedule a current packet. However, when the remaining quantum is smaller or does not exist, the scheduler is allowed to schedule the current packet upon scheduling a subsequent packet.

### SUMMARY OF THE INVENTION

It is an object of the present invention to provide a method and apparatus for queue management in a network processor which enable a queue manager and a scheduler in the network processor to synchronize a queue processing time therebetween.

It is another object of the present invention to provide a method and apparatus for queue management in a network processor which enables a scheduler in the network processor to obtain correct packet size information for scheduling.

One aspect of the present invention provides a queue management apparatus in a network processor including a packet processor, a queue manager, and a scheduler, the apparatus including: a queue manager adapted to output an enqueue completed message to the scheduler upon enqueuing in response to a packet output port number, a queue number, and packet identification information contained in an enqueue request message received from the packet processor having been completed, and to transmit a de-queue completed message containing de-queued port and queue numbers to the scheduler upon de-queuing in response to a de-queue request message from the scheduler having been completed; and a scheduler adapted to transmit the de-queue request message to the queue manager upon port and queue scheduling in response to the enqueue completed message from the queue manager having been completed, and updating the quantum of the port and queue in response to the de-queue completed message from the queue manager.

The queue manager is preferably adapted to increase a length of a queue array corresponding to the port and queue in the message by a predetermined length upon the enqueue request message being received, and to perform enqueuing to store the packet identification information in the queue array.

The scheduler is preferably adapted to update each bitmap corresponding to the port and queue numbers enqueued by the queue manager, to increase a length of a queue array corresponding to the updated port and queue by a predetermined length, and then to perform the scheduling upon the enqueue completed message being received. The scheduler is preferably adapted to schedule the updated port according to a Weighted Round Robin (WRR) scheme and to schedule the updated queue according to a Deficit Round Robin (DRR) scheme. The scheduler is preferably adapted to update a bitmap of the scheduled port and queue after performing the scheduling, to decrement a length of a queue array corresponding to the updated port and queue by a predetermined length, and then to generate the de-queue request message.

The queue manager is preferably adapted to decrement a length of the queue array corresponding to the scheduled port and queue by a predetermined length upon the de-queue request message being received, to de-queue first packet identification information from the queue array, to extract packet size information from the de-queued packet identification information, and to transmit the de-queue completed message containing the packet size information and the de-queued port and queue numbers to the scheduler.

The scheduler is preferably adapted to decrement the quantum of the port and queue by the size information using the packet size information and the port and queue numbers upon the de-queue completed message being received.

The queue manager is preferably adapted to transmit a message requesting the packet to be transmitted to the de-queued port upon the de-queuing being performed. The queue manager preferably includes: an enqueue request message receiver adapted to receive the enqueue request message from the packet processor; an enqueue processor adapted to perform an enqueuing operation in response to the enqueue request message; an enqueue completed message transmitter adapted to generate the enqueue completed message including information obtained by performing the enqueuing and to transmit it to the scheduler; a de-queue request message receiver adapted to receive the de-queue completed message from the scheduler; a de-queue processor adapted to perform a de-queuing in response to the de-queue request message; a de-queue completed message transmitter adapted to generate a de-queue completed message including the de-queued port and queue numbers and to transmit it to the scheduler upon the de-queuing being completed; and a transmission request message transmitter adapted to generate and transmit a message requesting the packet to be transmitted to the de-queued output port.

The scheduler preferably includes: an enqueue completed message receiver adapted to receive the enqueue completed message from the queue manager; a scheduling unit adapted to schedule the port and queue in response to the enqueue completed message; a de-queue request message transmitter adapted to generate a de-queue request message upon the scheduling being completed and to transmit it to the queue manager; and a de-queue completed message receiver adapted to update the quantum of the port and queue in response to the de-queue completed message received from the queue manager.

Another aspect of the present invention provides a queue management apparatus in a network processor including a packet processor, a queue manager, and a scheduler, the apparatus including: a queue manager adapted to output an enqueue completed message to the scheduler upon enqueuing in response to a packet output port number, a queue number, and packet identification information contained in an enqueue request message received from the packet processor being completed, and to transmit a de-queue completed message containing packet size information and de-queued port and queue numbers to the scheduler upon de-queuing in response to a de-queue request message from the scheduler being completed; and a scheduler adapted to transmit the de-queue request message to the queue manager upon port and queue scheduling in response to the enqueue completed message from the queue manager being completed, and to decrement a quantum of the port and queue by the packet size in response to the de-queue completed message from the queue manager.

The queue manager is preferably adapted to de-queue the first packet identification information from the queue array corresponding to the scheduled port and queue in response to the de-queue request message, to extract packet size information from the de-queued packet identification information, and to include it in the de-queue completed message.

Sill another aspect of the present invention provides a method of managing a queue in a network processor including a packet processor, a queue manager, and a scheduler, the method including: the queue manager enqueuing packet identification information in a queue array corresponding to a port and a queue using a packet output port number, a queue number, and the packet identification information contained in an enqueue request message received from the packet processor, generating an enqueue completed message, and transmitting it to the scheduler; the scheduler scheduling the port and the queue in response to the enqueue completed message and transmitting a de-queue request message to the queue manager; the queue manager performing de-queuing in response to the de-queue request message and transmitting a de-queue completed message containing de-queued port and queue numbers to the scheduler; and the scheduler updating a quantum of the port and queue in response to the de-queue completed message.

The queue manager enqueuing preferably includes increasing a length of a queue array corresponding to the port and queue contained in the received message by a predetermined length to perform enqueuing.

The scheduler scheduling preferably includes updating a bitmap of the port and queue respectively corresponding to the enqueued port and queue numbers, and increasing a length of the queue array corresponding to the updated port and queue by a predetermined length to performing scheduling. The scheduler scheduling preferably includes scheduling the updated port according to a Weighted Round Robin (WRR) scheme and scheduling the updated queue according to a Deficit Round Robin (DRR) scheme. The scheduler transmitting a de-queue request message preferably includes the scheduler updating a bitmap of the scheduled port and queue, and decreasing a length of a queue array corresponding to the updated port and queue by a predetermined length to generate the de-queue request message.

The queue manager de-queuing preferably includes decreasing a length of a queue array corresponding to the port and queue scheduled by the scheduler by a predetermined length, de-queuing first packet identification information from the queue array, and extracting the packet size information from the de-queued packet identification information.

The de-queue completed message preferably further includes the extracted packet size information.

The scheduler updating a quantum of the port and queue preferably includes decrementing the quantum of the port and queue by a packet size using the packet size information and port and queue numbers.

The method preferably further includes the queue manager transmitting a message requesting the packet to be transmitted to the de-queued port.

Yet another aspect of the present invention provides a method of managing a queue in a network processor including a packet processor, a queue manager, and a scheduler, the method including: the queue manager enqueuing packet identification information in a queue array corresponding to a port and a queue using a packet output port number, a queue number, and the packet identification information contained in an enqueue request message received from the packet processor, generating an enqueue completed message, and transmitting it to the scheduler; the scheduler scheduling the port and the queue in response to the enqueue completed message and transmitting a de-queue request message to the queue manager; the queue manager de-queuing first packet identification information from the queue array corresponding to the scheduled port and queue in response to the de-queue request message and transmitting a de-queue completed message containing packet size information and de-queued port and queue numbers to the scheduler; and the scheduler decrementing a quantum of the port and queue by the packet size in response to the de-queue completed message.

The queue manager de-queuing preferably includes de-queuing first packet identification information from the queue array corresponding to the scheduled port and queue, and extracting the packet size information from the de-queued packet identification information.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a network processor according to an exemplary embodiment of the present invention;

FIG. 2 is a view of the configuration of a queue manager according to an exemplary embodiment of the present invention;

FIG. 3 is a view of the configuration of a scheduler according to an exemplary embodiment of the present invention; and

FIG. 4 is a flowchart of queue management in a network processor according to an exemplary embodiment of the present invention.

### DETAILED DESCRIPTION OF THE INVENTION

Hereinafter, a method and apparatus for queue management in a network processor according to the present invention is described in detail below with reference to the accompanying drawings.

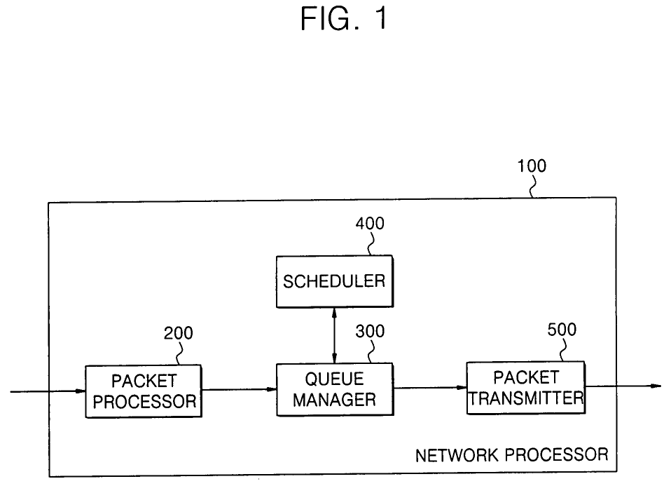

FIG. 1 is a block diagram of a network processor according to an exemplary embodiment of the present invention

Referring to FIG. 1, a network processor includes a packet processor 200, a queue manager 300, a scheduler 400, and a packet transmitter 500.

The packet processor 200 monitors a port through which a packet is received from a physical layer/data link layer, and stores the received packet in a buffer (not shown). Furthermore, the packet processor 200 performs packet processing, such as IP header processing, look-up, and the like.

The packet processor 200 transmits an enqueue request message to the queue manager 300 in order to transmit a normally processed packet. The enqueue request message can include packet identification information together with an output port number and a queue number. The packet identification information includes packet-related information, such as a packet size, a packet storage position, and the like.

The queue manager 300 performs enqueuing and de-queuing operations on the packet identification information received from the packet processor 200 and then generates an enqueue completed message and a de-queue completed message to transmit them to the scheduler 400. The queue manager 300 can extract packet size information from the de-queued packet identification information and include the extracted packet size information in the de-queue completed message, which is transmitted to the scheduler 400.

The scheduler 400 schedules a port and a queue used to enqueue or de-queue the packet identification information. The scheduler 400 can use a Weighted Round Robin (WRR) scheme to schedule the port and use a Deficit Round Robin (DRR) scheme to schedule the queue. The scheduler 400 can also synchronize enqueuing and de-queuing time with the queue manager 300 through the enqueue and de-queue completed messages received from the queue manager 300, and calculate a quantum of the de-queued port and queue based on the packet size information in the de-queue completed message.

The quantum refers to a bandwidth of each queue used when the scheduler 400 performs the scheduling operation as described above. The quantum is a value obtained by changing a relative ratio of queue bandwidths in the same port using a Maximum Transfer Unit (MTU) of the port.

The packet transmitter 500 transmits the packet to the scheduled output port.

A queue management operation of the network processor having such a configuration is described in detail as follows.

In the network processor, the packet processor 200 performs normal packet processing (e.g., IP header processing, look-up, L2 header encapsulation, etc.) on the received packet, and then transmits the enqueue request message to the queue manager 300. The enqueue request message contains an output port number, a queue number, and packet identification information.

The queue manager 300 receives the enqueue request message from the packet processor 200 and parses the received enqueue request message to detect the output port number, the queue number and the packet identification information from the message. The queue manager 300 increments a length of a queue array corresponding to the detected port and queue by “1” and performs an enqueuing operation to store the detected packet identification information in the queue array.

After performing the enqueuing operation, the queue manager 300 transmits the enqueue completed message to the scheduler 400. The enqueue completed message contains the port number and the queue number used to perform the enqueuing operation.

When the enqueue completed message is received from the queue manager 300, the scheduler 400 parses the received enqueue request message to detect the enqueued port and queue numbers. The scheduler 400 updates bitmaps respectively corresponding to the detected port and queue numbers, indicates that they are to be scheduled, and increments the length of the queue array corresponding to the port and queue by “1.”

After incrementing the length of the queue array, the scheduler 400 schedules the detected port and queue. The scheduler 400 schedules the port according to the WRR scheme and schedules the queue according to the DRR scheme. Furthermore, the scheduler 400 performs queue scheduling when there is a quantum for the port and queue.

The scheduler 400 then updates the bitmaps of the scheduled port and queue and decrements the length of the queue array corresponding to the port and queue by “1.” This can prevent a scheduling error that can be caused by a difference in performance between the queue manager 300 and the scheduler 400.

The scheduler 400 then generates a de-queue request message requesting a de-queuing operation and transmits it to the queue manager 300. The de-queue request message contains the scheduled port and queue numbers.

Upon receipt of the de-queue request message from the scheduler 400, the queue manager 300 parses the received message to detect the scheduled port and queue numbers. The queue manager 300 decrements the length of the queue array corresponding to the detected port and queue numbers by “1” and de-queues first packet identification information from the queue array.

The queue manager 300 parses the de-queued packet identification information to extract the packet size information, generates the de-queue completed message containing the extracted packet size and the de-queued port and queue numbers, and transmits it to the scheduler 400.

Upon receipt of the de-queue completed message from the queue manager 300, the scheduler 400 detects the packet size and the port and queue numbers from the received message and decrements a quantum of the detected port and queue by the detected packet size.

After transmitting the generated de-queue completed message to the scheduler 400, the queue manager 300 generates a message requesting the packet to be transmitted to the packet transmitter 500.

The configurations of the queue manager 300 and the scheduler 400 performing such a queue management operation in the network processor are described in detail as follows.

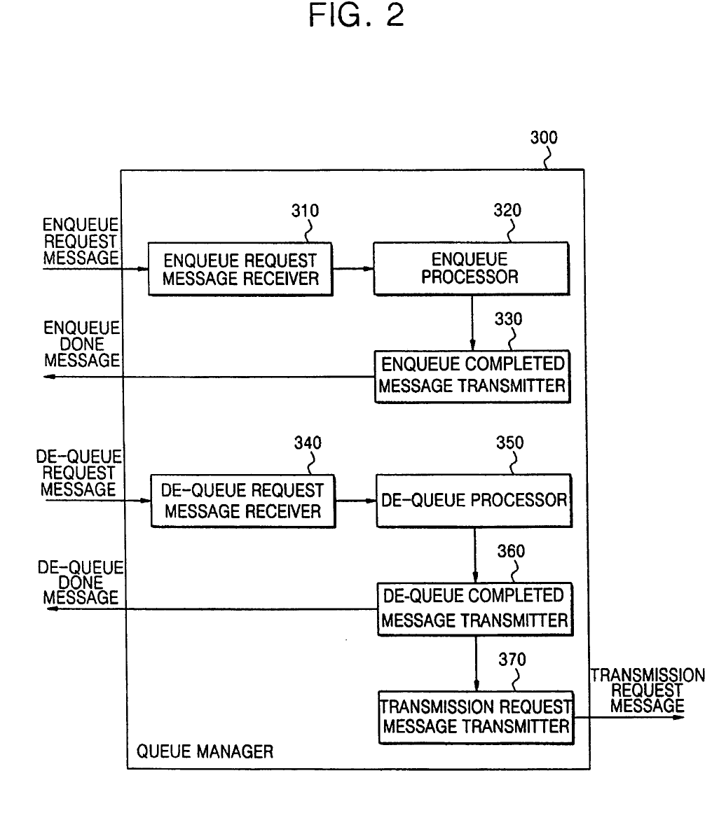

FIG. 2 is a view of the configuration of a queue manager according to an exemplary embodiment of the present invention.

Referring to FIG. 2, a queue manager 300 includes an enqueue request message receiver 310, an enqueue processor 320, an enqueue completed message transmitter 330, a de-queue request message receiver 340, a de-queue processor 350, a de-queue completed message transmitter 360, and a transmission request message transmitter 370.

The enqueue request message receiver 310 increases a length of a queue array in response to an enqueue request message received from the packet processor 200. The enqueue request message includes an output port number, a queue number, and packet identification information.

The enqueue processor 320 performs an enqueuing operation to store, in the queue, the packet identification information which is included in the enqueue request message from the packet processor 200.

The enqueue completed message transmitter 330 generates an enqueue completed message containing information obtained by performing the enqueuing operation and transmits it to the scheduler 400.

The de-queue request message receiver 340 receives a message requesting a de-queuing operation to be performed from the scheduler 400.

The de-queue processor 350 de-queues the packet identification information from the actual queue array.

The de-queue completed message transmitter 360 extracts a packet size from the de-queued packet identification information, generates a de-queue completed message containing the extracted packet size, and transmits it to the scheduler 400.

The transmission request message transmitter 370 generates a message requesting the packet to be transmitted to the de-queued output port and transmits it to the packet transmitter 500 to be transmitted.

The operation of the queue manager 300 having such a configuration is described as follows. The enqueue request message receiver 310 of the queue manager 300 receives an enqueue request message from the packet processor 200 and parses the received message. The enqueue request message receiver 310 then detects the output port number, the queue number, and the packet identification information from the received message, and increments the length of the queue array corresponding to the detected port and queue by “1.” The enqueue request message receiver 310 generates the enqueue request information containing the detected port and queue numbers and the packet identification information, and outputs the enqueue request information to the enqueue processor 320.

The enqueue processor 320 receives the enqueue request information from the enqueue request message receiver 310 and stores the received packet identification information in the queue array corresponding to the received port and queue numbers.

After performing the enqueuing operation, the enqueue processor 320 generates the enqueuing completed information and outputs it to the enqueue completed message transmitter 330. The enqueue completed information contains the port and queue numbers through which the enqueuing operation is performed.

The enqueue completed message transmitter 330 receives the enqueue completed information from the enqueue processor 320 and generates an enqueue completed message containing the received enqueue completed information. The enqueue completed message transmitter 330 then transmits the generated enqueue completed message to the scheduler 400.

After transmitting the enqueue completed message to the scheduler 400 via the enqueue completed message transmitter 330, the queue manager 300 receives the de-queue request message requesting the de-queuing operation to be performed from the scheduler 400 via the de-queue request message receiver 340. The de-queue request message contains the port number and the queue number selected through the scheduling process performed at the scheduler 400.

The de-queue request message receiver 340 receives the de-queue request message from the scheduler 400 and parses the received message to detect the scheduled port and queue numbers. The de-queue request message receiver 340 decrements the length of the queue array corresponding to the detected port and queue by “1,” generates de-queue request information containing the detected port and queue numbers, and outputs it to the de-queue processor 350.

The de-queue processor 350 receives the de-queue request information from the de-queue request message receiver 340, and de-queues first packet identification information from the queue array corresponding to the port and queue numbers according to the received information.

The de-queue processor 350 parses the de-queued packet identification information to extract packet size information and outputs de-queue completed information containing the extracted packet size information and the de-queued port and queue numbers to the de-queue completed message transmitter 360.

Upon receipt of the de-queue completed information from the de-queue processor 350, the de-queue completed message transmitter 360 generates a de-queue completed message containing the received de-queue completed information and outputs it to the scheduler 400 and the transmission request message transmitter 370.

When the transmission request message transmitter 370 receives the de-queue completed message from the de-queue completed message transmitter 360, it parses the de-queue completed message, determines that de-queuing is completed, generates a transmission request message requesting the packet to be transmitted to the de-queued port, and transmits it to the packet transmitter 500.

In this manner, the queue manager 300 performs the enqueuing and de-queuing operations, generates the enqueue completed message and the de-queue completed message, and transmits them to the scheduler 400 to synchronize the queue processing time with the scheduler 400.

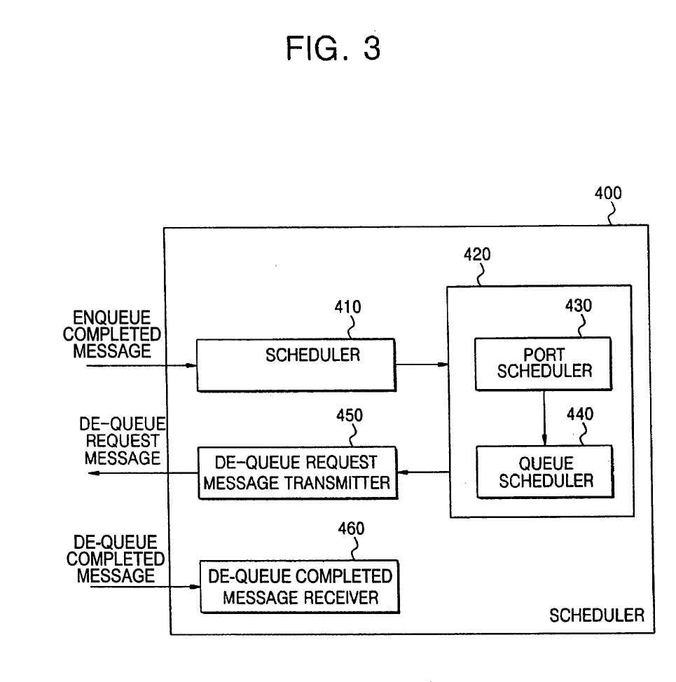

FIG. 3 is a view of the configuration of a scheduler according to an exemplary embodiment of the present invention.

Referring to FIG. 3, the scheduler 400 includes an enqueue completed message receiver 410, a scheduling unit 420, a de-queue request message transmitter 450, and a de-queue completed message receiver 460.

The enqueue completed message receiver 410 receives the enqueue completed message from the queue manager 300 and increases the length of the queue array.

The scheduling unit 420 includes a port scheduler 430 and a queue scheduler 440. The port scheduler 430 schedules the port according to a WRR algorithm, and the queue scheduler 440 schedules the queue in the scheduled port according to DRR algorithm.

The de-queue request message transmitter 450 generates a de-queue request message containing the scheduled port and queue numbers and transmits it to the queue manager 300.

The de-queue completed message receiver 460 receives a de-queue completed message from the de-queue manager 300 and updates a quantum and an internal data structure of the queue array corresponding to the de-queued port and queue.

The operation of the scheduler 400 having such a configuration is described as follows. The scheduler 400 receives the enqueue completed message from the queue manager 300 via the enqueue completed message receiver 410.

Upon receipt of the enqueue completed message from the queue manager 300, the enqueue completed message receiver 410 parses the received message to detect the enqueued port and queue numbers from the message. The enqueue completed message receiver 410 updates each bitmap corresponding to the detected port and queue numbers to indicate that it is to be scheduled, and increments the length of the queue array corresponding to the port and queue by “1.”

The enqueue completed message receiver 410 generates enqueue completed information containing the detected port and queue numbers and outputs it to the scheduling unit 420.

Upon receipt of the enqueue completed information from the enqueue completed message receiver 410, the scheduling unit 420 schedules the port in the received enqueue completed information through the port scheduler 430. The port scheduler 430 can perform port scheduling operation according to the WRR scheme. Furthermore, the scheduling unit 420 schedules the queue in the port contained in the received enqueue completed information through the queue scheduler 440. The queue scheduling can schedule the port according to the DRR scheme. Furthermore, the scheduler 400 performs scheduling only when there is a quantum for the port and queue.

The scheduling unit 420 updates the bitmaps of the scheduled port and queue and decrements the length of the queue array corresponding to the port and the queue by “1.” This can prevent scheduling errors caused by a difference in performance between the queue manager 300 and the scheduler 400.

After performing the scheduling operation, the scheduling unit 420 generates scheduling completed information and outputs it to the de-queue request message transmitter 450. The scheduling completed information contains the scheduled port and queue numbers.

When the de-queue request message transmitter 450 receives the scheduling completed information from the scheduling unit 420, it generates scheduling completed information, i.e., a de-queue request message containing the scheduled port and queue numbers as a de-queue request message. The de-queue request message transmitter 450 transmits the generated de-queue request message to the queue manager 300.

After transmitting the de-queue request message to the queue manager 300 via the de-queue request message transmitter 450, the scheduler 400 receives the de-queue completed message from the queue manager 300 via the de-queue completed message receiver 460. The de-queue completed message contains size information of the de-queued packet, and the de-queued port and queue numbers.

Upon receipt of the de-queue completed message from the queue manager 300, the de-queue completed message receiver 460 detects the packet size information and the port and queue numbers from the received message, and decreases each quantum corresponding to the detected port and queue by the detected packet size information.

In this manner, the scheduler 400 synchronizes a queue processing time with the queue manager 300 through the enqueue and de-queue completed messages from the queue manager 300, and calculates a correct quantum of the scheduled port and queue based on the packet size information in the de-queue completed message.

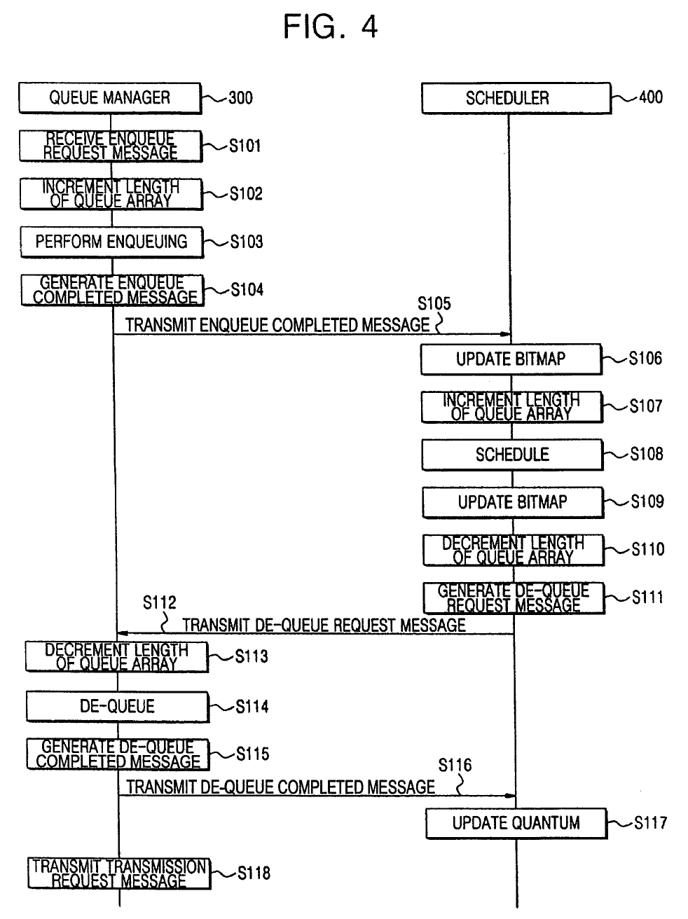

FIG. 4 is a flowchart of queue management in a network processor according to an exemplary embodiment of the present invention.

Referring to FIG. 4, the queue manager 300 receives the enqueue request message from the packet processor 200 (S101). The enqueue request message contains the output port number, the queue number, and the packet identification information.

The queue manager 300 parses the received enqueue request message to detect the output port number, the queue number, and the packet identification information from the message and increments a length of the queue buffer corresponding to the detected port and queue by “1” (S102).

The queue manager 300 performs enqueuing to store the detected packet identification information in the queue buffer corresponding to the detected port and queue numbers (S103).

The queue manager 300 then generates an enqueue completed message (S104) and transmits it to the scheduler 400 (S105). The enqueue completed message contains the port and the queue numbers used for enqueuing operation.

Upon receipt of the enqueue completed message, the scheduler 400 parses the received message to detect the enqueued port and queue numbers from the message, updates each bitmap corresponding to the detected port and queue numbers, and indicates that they are to be scheduled (S106). The scheduler 400 increments the length of the queue array corresponding to the detected port and queue by “1” (S107).

The scheduler 400 schedules the detected port and queue (S108). The scheduler 400 performs port scheduling according to the WRR scheme and queue scheduling according to the DRR scheme. The scheduler 400 also performs scheduling only when there is a quantum for the port and queue.

The scheduler 400 updates the bitmaps of the scheduled port and queue (S109) and decrements the length of the queue array corresponding to the port and queue by “1” (S110).

The scheduler 400 generates the de-queue request message (S111), and transmits it to the queue manager 300 (S112). The de-queue request message contains the scheduled port and queue numbers.

Upon receipt of the de-queue request message, the queue manager 300 parses the message received from the scheduler 400 to detect the scheduled port and queue numbers and decrements the length of the queue array corresponding to the detected port and queue numbers by “1” (S113), and then de-queues first packet identification information from the queue array (S114).

The queue manager 300 parses the de-queued packet identification information to extract size information of the packet and generates a de-queue completed message containing the extracted packet size and the de-queued port and queue numbers (S115). The queue manager 300 transmits the generated de-queue completed message to the scheduler 400 (S116).

Upon receipt of the de-queue completed message, the scheduler 400 detects the packet size and the port and queue numbers from the received message, and decrements a quantum of the port and queue corresponding to the detected port and queue by the detected packet size (S117).

The queue manager 300 transmits the generated de-queue completed message to the scheduler 400, generates a message requesting the packet to be transmitted to the de-queued port, and transmits the message to the packet transmitter 500, such that the packet is transmitted via the packet transmitter 500 (S118).

In a method and apparatus for managing a queue in a network processor according to the present invention, enqueue completed and de-queue completed messages are transmitted to a scheduler when a queue manager performs enqueuing and de-queuing operations in the network processor, so that the queue processing time is synchronized between the queue manager and the scheduler.

In addition, the queue manager in the network processor performs the de-queuing operation, includes the packet size information extracted from de-queued packet identification information in the de-queue completed message, and transmits it to the scheduler, so that the scheduler calculates the correct quantum of the port and queue.

While the present invention has been described with reference to exemplary embodiments thereof, it will be understood by those skilled in the art that various modifications in form and detail can be made therein without departing from the scope of the present invention as defined by the following claims.

What is claimed is:

1. A queue management apparatus in a network processor including a packet processor, a queue manager, and a scheduler, the apparatus comprising:
a queue manager adapted to output an enqueue completed message to the scheduler upon enqueuing in response to a packet output port number, a queue number, and packet identification information contained in an enqueue request message received from the packet processor having been completed, and to transmit a de-queue completed message containing de-queued port and queue numbers to the scheduler upon de-queuing in response to a de-queue request message from the scheduler having been completed; and
a scheduler adapted to transmit the de-queue request message to the queue manager upon port and queue scheduling in response to the enqueue completed message from the queue manager having been completed, and updating the quantum of the port and queue in response to the de-queue completed message from the queue manager.

2. The apparatus of claim 1, wherein the queue manager is adapted to increase a length of a queue array corresponding to the port and queue in the message by a predetermined length upon the enqueue request message being received, and to perform enqueuing to store the packet identification information in the queue array.

3. The apparatus of claim 1, wherein the scheduler is adapted to update each bitmap corresponding to the port and queue numbers enqueued by the queue manager, to increase a length of a queue array corresponding to the updated port and queue by a predetermined length, and then to perform the scheduling upon the enqueue completed message being received.

4. The apparatus of claim 3, wherein the scheduler is adapted to schedule the updated port according to a Weighted Round Robin (WRR) scheme and to schedule the updated queue according to a Deficit Round Robin (DRR) scheme.

5. The apparatus of claim 1, wherein the scheduler is adapted to update a bitmap of the scheduled port and queue after performing the scheduling, to decrement a length of a queue array corresponding to the updated port and queue by a predetermined length, and then to generate the de-queue request message.

6. The apparatus of claim 1, wherein the queue manager is adapted to decrement a length of the queue array corresponding to the scheduled port and queue by a predetermined length upon the de-queue request message being received, to de-queue first packet identification information from the queue array, to extract packet size information from the de-queued packet identification information, and to transmit the de-queue completed message containing the packet size information and the de-queued port and queue numbers to the scheduler.

7. The apparatus of claim 6, wherein the scheduler is adapted to decrement the quantum of the port and queue by the size information using the packet size information and the port and queue numbers upon the de-queue completed message being received.

8. The apparatus of claim 1, wherein the queue manager is adapted to transmit a message requesting the packet to be transmitted to the de-queued port upon the de-queuing being performed.

9. The apparatus of claim 1, wherein the queue manager comprises:
an enqueue request message receiver adapted to receive the enqueue request message from the packet processor;
an enqueue processor adapted to perform an enqueuing operation in response to the enqueue request message;
an enqueue completed message transmitter adapted to generate the enqueue completed message including information obtained by performing the enqueuing and to transmit it to the scheduler;
a de-queue request message receiver adapted to receive the de-queue completed message from the scheduler;
a de-queue processor adapted to perform a de-queuing in response to the de-queue request message;
a de-queue completed message transmitter adapted to generate a de-queue completed message including the de-queued port and queue numbers and to transmit it to the scheduler upon the de-queuing being completed; and
a transmission request message transmitter adapted to generate and transmit a message requesting the packet to be transmitted to the de-queued output port.

10. The apparatus of claim 1, wherein the scheduler comprises:
an enqueue completed message receiver adapted to receive the enqueue completed message from the queue manager;
a scheduling unit adapted to schedule the port and queue in response to the enqueue completed message;
a de-queue request message transmitter adapted to generate a de-queue request message upon the scheduling being completed and to transmit it to the queue manager; and
a de-queue completed message receiver adapted to update the quantum of the port and queue in response to the de-queue completed message received from the queue manager.

11. A queue management apparatus in a network processor including a packet processor, a queue manager, and a scheduler, the apparatus comprising:
a queue manager adapted to output an enqueue completed message to the scheduler upon enqueuing in response to a packet output port number, a queue number, and packet identification information contained in an enqueue request message received from the packet processor being completed, and to transmit a de-queue completed message containing packet size information and de-queued port and queue numbers to the scheduler upon de-queuing in response to a de-queue request message from the scheduler being completed; and
a scheduler adapted to transmit the de-queue request message to the queue manager upon port and queue scheduling in response to the enqueue completed message from the queue manager being completed, and to decrement a quantum of the port and queue by the packet size in response to the de-queue completed message from the queue manager.

12. The apparatus of claim 11, wherein the queue manager is adapted to de-queue the first packet identification information from the queue array corresponding to the scheduled port and queue in response to the de-queue request message, to extract packet size information from the de-queued packet identification information, and to include it in the de-queue completed message.

13. A method of managing a queue in a network processor including a packet processor, a queue manager, and a scheduler, the method comprising:
the queue manager enqueuing packet identification information in a queue array corresponding to a port and a queue using a packet output port number, a queue number, and the packet identification information contained in an enqueue request message received from the packet processor, generating an enqueue completed message, and transmitting it to the scheduler;
the scheduler scheduling the port and the queue in response to the enqueue completed message and transmitting a de-queue request message to the queue manager;
the queue manager performing de-queuing in response to the de-queue request message and transmitting a de-queue completed message containing de-queued port and queue numbers to the scheduler; and
the scheduler updating a quantum of the port and queue in response to the de-queue completed message.

14. The method of claim 13, wherein the queue manager enqueuing comprises increasing a length of a queue array corresponding to the port and queue contained in the received message by a predetermined length to perform enqueuing.

15. The method of claim 13, wherein the scheduler scheduling comprises updating a bitmap of the port and queue respectively corresponding to the enqueued port and queue numbers, and increasing a length of the queue array corresponding to the updated port and queue by a predetermined length to performing scheduling.

16. The method of claim 13, wherein the scheduler scheduling comprises scheduling the updated port according to a Weighted Round Robin (WRR) scheme and scheduling the updated queue according to a Deficit Round Robin (DRR) scheme.

17. The method of claim 13, wherein the scheduler transmitting a de-queue request message comprises the scheduler updating a bitmap of the scheduled port and queue, and decreasing a length of a queue array corresponding to the updated port and queue by a predetermined length to generate the de-queue request message.

18. The method of claim 13, wherein the queue manager de-queuing comprises decreasing a length of a queue array corresponding to the port and queue scheduled by the scheduler by a predetermined length, de-queuing first packet identification information from the queue array, and extracting the packet size information from the de-queued packet identification information.

19. The method of claim 18, wherein the de-queue completed message further comprises the extracted packet size information.

20. The method of claim 18, wherein the scheduler updating a quantum of the port and queue comprises decrementing the quantum of the port and queue by a packet size using the packet size information and port and queue numbers.

21. The method of claim 13, further comprising the queue manager transmitting a message requesting the packet to be transmitted to the de-queued port.

22. A method of managing a queue in a network processor including a packet processor, a queue manager, and a scheduler, the method comprising:
the queue manager enqueuing packet identification information in a queue array corresponding to a port and a queue using a packet output port number, a queue number, and the packet identification information contained in an enqueue request message received from the packet processor, generating an enqueue completed message, and transmitting it to the scheduler;
the scheduler scheduling the port and the queue in response to the enqueue completed message and transmitting a de-queue request message to the queue manager;
the queue manager de-queuing first packet identification information from the queue array corresponding to the scheduled port and queue in response to the de-queue request message and transmitting a de-queue completed message containing packet size information and de-queued port and queue numbers to the scheduler; and
the scheduler decrementing a quantum of the port and queue by the packet size in response to the de-queue completed message.

23. The method of claim 22, wherein the queue manager de-queuing comprises de-queuing first packet identification information from the queue array corresponding to the scheduled port and queue, and extracting the packet size information from the de-queued packet identification information.
